(19) United States
(12) Patent Application Publication
(10) Pub. No.: US 2007/0052251 A1
(43) Pub. Date: Mar. 8, 2007

(54) Locking arrangement

(76) Inventors: Pekka Hautala, Espoo (FI); Petri Makkonen, Helsinki (FI); Juha Murtola, Joensuu (FI); Mika Helisten, Ylamylly (FI); Kimmo Siitari, Joensuu (FI)

Correspondence Address: SMITH-HILL AND BEDELL, P.C., 16100 NW CORNELL ROAD, SUITE 220, BEAVERTON, OR, 97006, US

(21) Appl. No.: 10/575,610

(22) PCT Filed: Sep. 23, 2004
(86) PCT No.: PCT/FI04/00558

§ 371 Date: Jun. 14, 2006

(30) Foreign Application Priority Data
Oct. 14, 2003 (FI) 20031495

(51) Int. Cl. E05B 15/02

(52) U.S. Cl. 292/341.18

(57) ABSTRACT

The present invention relates to a locking arrangement by means of which two parts can be locked to each other, such as locking a door to its frame construction. The locking arrangement comprises a first locking element fastened to the lock unit, a second locking element fastened to the counter part and an acting element being preferably a part of the lock unit. The first and second locking elements are gripping brackets, forming a hooked grip with each other when the lock unit and the counter part are against each other, when, for example, the door is locked in its opening. The gripping brackets are essentially in the direction of the movement of the door. The task of the acting element is to keep the gripping brackets in an overlapping position when the locking arrangement is locked. The position of the acting can be changed, and the current state of the locking arrangement depends on the position.

### FIELD OF THE INVENTION

The present invention relates to a locking arrangement for locking two parts to each other, such as locking a door or a hatch to the frame construction of a door or hatch opening.

### BACKGROUND OF THE TECHNOLOGY

FIG. 1 illustrates a normal locking arrangement comprising a lock unit 4 and counter part 5. Usually, the lock unit is installed in a door 1 and the counter part 5 is installed in the door frame 2, but other ways of installing are also possible. Latch 6 is moved (pushed or turned) from the lock unit to the counter part, i.e. the striker plate. In the example of FIG. 1 the striker plate is installed in the door frame, and it can be seen that upon locking the door the latch is pushed into a hole in the door frame and the striker plate.

The necessary movement of the latch must be sufficient to keep the door closed in, for example, cases of vandalism, despite the door clearance, i.e. the gap 8 between the door and the frame, the clearance fluctuating on the basis of the door type, the installation tolerances, temperature etc. Typically, the door clearance is between 1 and 5 mm. Usually, the movement of the latch is 14 mm, or in a door of a higher security rating, even 20 mm. The latch is moved by, for example, a key, an electric motor or a button.

Usually, the movement of the latch is transverse to the movement of the door (direction of opening and closing), so that the force exerted on the door upon opening, such as a sealing force caused by the seal 3 or pushing the door, will make the movement of the latch considerably more difficult, because there is friction between it and, for example, the striker plate. There is friction in the inner components of the lock as well, between 7 the latch and other components of the lock unit. This means also that when opening the lock by means of a key or an electric motor, plenty of force is needed to overcome the forces and friction, if any.

Additionally, during burglary, considerable bending stress is exerted on the latch, so that the components will have to be massively dimensioned.

Because of the great force needed to move the latch and the relatively large movement of the latch, the energy needed is usually too large for battery operation. Additionally, powerful and expensive motor gearings are needed. As far as energy consumption is needed, panic exit regulations (standard EN 1125) must be considered, according to which a locked door must be capable of being opened, even though a transverse force of 1000 Newton is exerted in the central part of the door. Fulfilling this requirement using currently known solutions is very difficult and expensive.

Further, a number of sensors has previously been used for sensing the state of the object to be locked, such as a door. Separate sensors have been used for indicating, for example, whether the door is open, the locking locked and the locking open. The aim of the present invention is to reduce the above-mentioned problems of the prior art. The aim is achieved as disclosed in the claims.

### BRIEF DESCRIPTION OF THE INVENTION

The system according to the invention has a new mechanism, by means of which the known locking, based on latch, can be replaced. Instead of a latch, the invention uses a first locking element, attached to the lock unit, a second locking element, attached to the counter part, i.e. to the striker plate at its simplest, and an acting element, being preferably a part of the lock unit.

The first and second locking elements are gripping brackets, forming a hooked grip with each other when the lock unit and the counter part are in their installation position against each other, for example, when the door is closed in its opening. Thus, the locking elements can be described as two catches, gripping each other when they are in a position overlapping each other (in contact with each other, that the parts stay essentially in contact with each other regardless of a certain external force or with the external force even facilitating maintaining the contact). In the installation position (such as with the units being fastened to the door and the frame) the gripping brackets are mainly transversely in relation to the swing axis of the part to be turned (such as a door), i.e. the gripping brackets are essentially in the direction of the path of movement when the part to be turned is against the counter part thereof—such as when the door is shut in the door opening. The hookedness of the gripping brackets depends on their design. Using a suitable design, the hookedness can be very small, such as only shallow curves in the brackets.

The task of the acting element is to keep the gripping brackets in an overlapping position when the locking arrangement according to the invention is locked. The position of the acting element can be changed, and the current state of the locking arrangement depends on the position. There is a gap between the acting element and the first locking element, the width of which depends on the said position. The second gripping bracket is in this gap when the brackets are overlapping each other.

When the gap is at its narrowest, there is just room for the second gripping bracket. Thus, the acting element and/or the first gripping bracket can press the second gripping bracket or a small gap will remain on both sides of the second gripping bracket. The gripping brackets and the acting element are formed so that when the gap is at its narrowest (the acting element is then in the front position) and the acting element is locked, the second gripping bracket can not be pulled away from between the acting element and the first gripping bracket, but the brackets stay in an overlapping position. When the gripping brackets are fastened to the lock unit and the counter part from their one end, and these are respectively fastened to, for example, the door and the door frame, the desired locking is accomplished.

If the acting element is not locked and the gap is at its narrowest, the second gripping bracket can be drawn away from between the acting element and the first gripping bracket, whereby the second gripping bracket simultaneously presses the acting element from the front position to the withdrawn position, whereby the gap is at its widest. In practice, in a real installation situation drawing the gripping bracket away from the gap means opening the door. In this case it is preferable to keep the acting element in withdrawn position, i.e. the gap is wide, because when an open door is being closed, it is easier for the second gripping element to enter the gap, i.e. overlap with the first gripping bracket. Simultaneously with the second gripping bracket entering the gap, it can release the acting element from the withdrawn position, whereby it is allowed to move to the front position.

Essentially and preferably the acting element is a vertical arm, hinged by its first end (in the examples of this text the upper end) to the body of the lock unit. The hinge forms a support, around which the arm can turn. In the front position the arm is in its nearest position to the first locking element, whereby the above-mentioned gap is at its narrowest. In the withdrawn position the arm is farther away in relation to the first locking element, whereby the above-mentioned gap is at its widest. The surface of the arm facing the first locking element includes a gripping tongue, the shape of which follows that of the locking element.

The arm can also include a groove, with a holding spring located therein for keeping the arm in the above-mentioned withdrawn position. When a pressing force is exerted on the release bracket of the holding spring, the holding spring moves away from the groove, whereby the arm can move to the front position.

The acting element can be locked in its front position by means of a safety catch that presses the rear edge of the arm of the acting element. The safety catch comprises a reel, the centre of which is on the side of the rear edge of the arm of the acting element, while the circumference of the roll presses the rear edge of the arm when the safety catch is on. When the safety catch is off, the central part of the reel is outside the rear edge of the arm, whereby the reel allows the arm to be moved into its withdrawn position by an external force.

The reel is fastened to the arm of the catch (preferably by its central part). The arm is fastened (e.g. hinged) by one end, the fastening end, to the body of the lock unit. The other end of the arm is hinged to the drive construction. The drive construction transmits the power to move the safety catch (the reel) on and off from, for example, an electric motor or a mechanical power apparatus, such as a key or a lock handle.

If the safety catch is not on, it will allow the acting element to move to the withdrawn position when a pressing force is exerted on the acting element (in practice the pressing of the gripping bracket against the acting element), In closer detail, the mechanics of the safety catch and the drive construction moves because of the acting force, allowing the arm of the acting element to move to the withdrawn position. When the arm is returned from the withdrawn position to the front position, the mechanics of the safety catch and the drive construction returns back to its starting state, i.e. to the state, in which the mechanics were before the force pressing the acting element moved it to the withdrawn position.

Thus, the invention relates to a locking arrangement, comprising a first locking element comprising a first free end that in installation position is mainly transversely in relation to the swing axis of the part to be turned, and a second locking element, belonging to the counter part and comprising a second free end being in the installation position mainly transversely in relation to the swing axis of the part to be turned. The locking elements are arranged to work together so that when the said units are against each other in the installation position while the door, hatch or the like is in closed position, they are overlapping each other. Additionally, the arrangement comprises an acting element, being controllably supported for achieving locking and which for achieving locking is arranged to act transversely in relation to the said locking means so that in the said position the overlapping locking elements together with the acting element prevent the lock unit and the counter part from moving away from the said contacting position by causing the said units to grip each other.

### LIST OF FIGURES

In the following, the invention is described by way of example, with reference to the appended figures, of which

FIG. 1 illustrates an example of prior art, i.e. a normal latch lock,

FIG. 2 illustrates a simple example of a construction according to the invention seen from above with the locking arrangement installed in the door and the door frame,

FIG. 3 illustrates another simple example of a construction according to the invention, seen from above with the locking arrangement installed in the door and the frame and with the locking elements formed differently from those of FIG. 2,

FIG. 4 illustrates a simple exemplary situation of an acting element according to the invention seen from the side,

FIG. 5 illustrates another simple exemplary situation of an acting element according to the invention seen from the side,

FIG. 6 illustrates a third simple exemplary situation of an acting element according to the invention seen from the side,

FIG. 7 illustrates an example of the form of the gripping brackets and of adjusting the locking arrangement for different door clearances,

FIG. 8 illustrates a first example of the drive construction of the lock unit with the safety catch on,

FIG. 9 illustrates a sectional view of FIG. 8, seen from the same direction,

FIG. 10 illustrates a sectional view of FIG. 8 from the indicated direction and location,

FIG. 11 illustrates a partial enlarged view of a part indicated in FIG. 9,

FIG. 12 illustrates a first example of the drive construction of the lock unit with the safety catch off,

FIG. 13 illustrates a sectional view of FIG. 12, seen from the same direction,

FIG. 14 illustrates a sectional view of FIG. 12 from the indicated direction and location,

FIG. 15 illustrates a partial enlarged view of a part indicated in FIG. 13,

FIG. 16 illustrates a first example of the drive construction of the lock unit with the safety catch off and the acting element in withdrawn position,

FIG. 17 illustrates a sectional view of FIG. 16, seen from the same direction,

FIG. 18 illustrates a sectional view of FIG. 16 from the indicated direction and location,

FIG. 19 illustrates a partial enlarged view of a part indicated in FIG. 17,

FIG. 20 illustrates another example of the drive construction of the lock unit with the safety catch on,

FIG. 21 illustrates another example of the drive construction of the lock unit with the safety catch off,

FIG. 22 illustrates another example of the drive construction of the lock unit with the safety catch off and the acting element in withdrawn position,

FIG. 23 illustrates an example of the holding spring of the locking arrangement,

FIG. 24 illustrates an example of how the second locking element acts on the holding spring,

FIG. 25 illustrates an example of the operation of the holding means in cooperation with the locking element and the acting element,

FIG. 26 is an exemplary flow chart of the method according to the invention.

FIG. 27 illustrates a further example of a drive construction and a safety catch, where the acting element is at the front position,

FIG. 28 illustrates the drive construction and the safety catch of FIG. 27 wherein the safety catch has been driven open,

FIG. 29 illustrates the drive construction and the safety catch of FIG. 27 wherein the acting element is at the back position, and

FIG. 30 shows a drive and a worm wheels of the drive construction of FIG. 27-29.

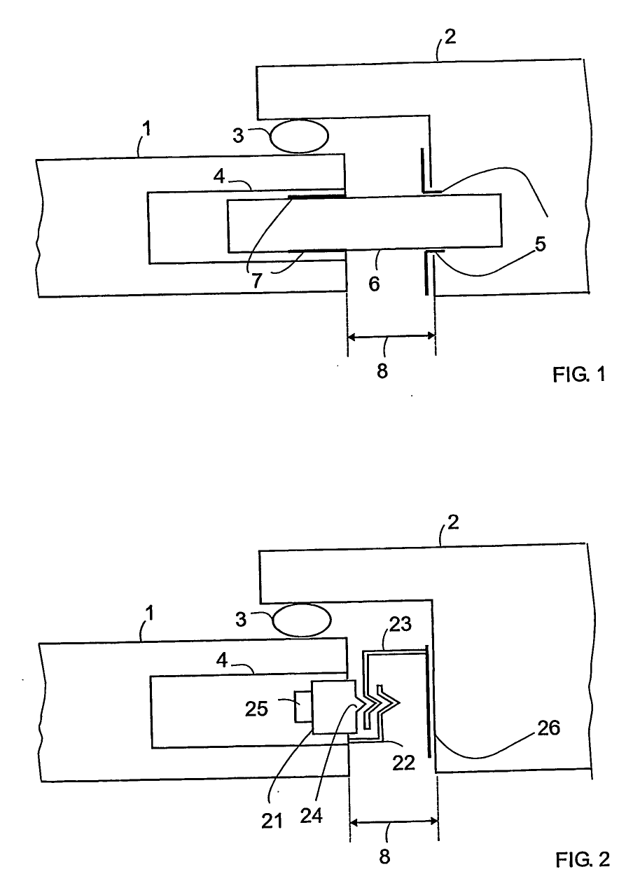

### DESCRIPTION OF THE INVENTION

FIG. 2 illustrates a simple example of a construction according to the invention seen from above with the locking arrangement installed in the door 1 and the door frame 2, In the example of FIG. 2 the lock unit 4 is installed in the door and the counter part 26 is installed in the door frame. The first locking element, i.e. the gripping bracket 22, is fastened to the lock unit (the body thereof) and the second lock unit, i.e. gripping bracket 23, is fastened to the counter part. In the situation illustrated in the figure, with the door closed in the door opening, the gripping brackets 22, 23 are overlapping each other.

The lock unit also comprises the acting element 21, the gripping bracket 24 of which is formed following the shapes of the gripping brackets 22, 23. Thus, when the gap between the bracket 22 of the first locking element and the actuating element is at its narrowest, i.e. when the acting element is in the front position, the second locking element 23 has just enough room to be located in the opening, whereby the shape of the acting element and the brackets keep the bracket of the second locking element in the gap, if the acting element is locked.

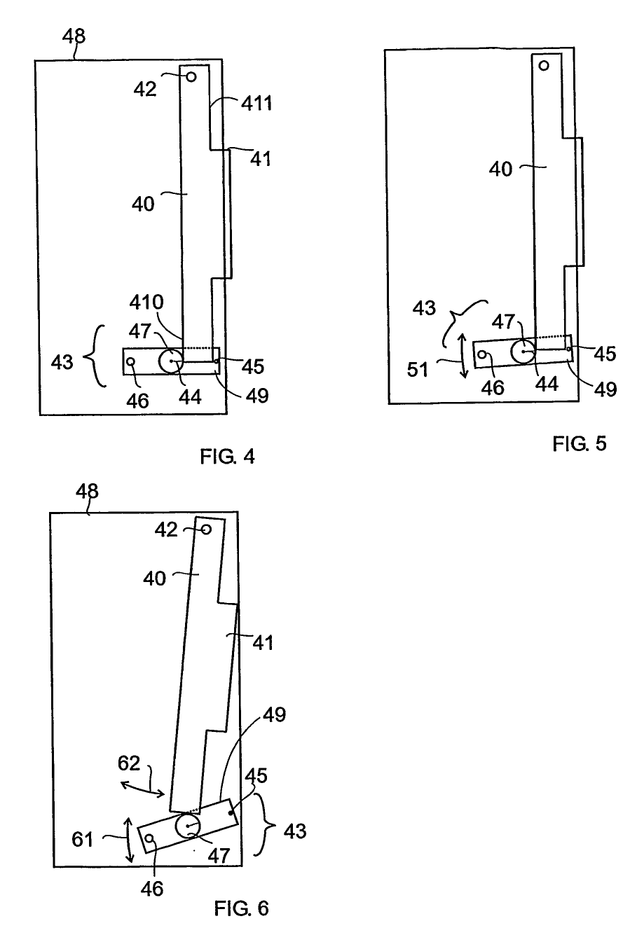

The locking of the acting element can be achieved by means of a safety catch, pressing the rear surface of the acting element. The safety catch is used for achieving the controlled support of the acting element. The safety catch is a means for locking the acting element into a certain position, in this case the front position. Thus, the external force acting on the acting element does not move the safety catch to another position. In this position the safety catch is said to be on. In more detail, the safety catch comprises a reel part 25, pressing the acting element. If the safety catch is not on (off), i.e. the reel does not firmly press the rear surface of the acting element (410, e.g. FIG. 4) when the door is pulled open the second locking element 23 presses on the acting element, whereby the reel does not firmly support and the acting element is allowed to move towards its withdrawn position. Simultaneously, the gap between the first locking element 22 and the acting element widens and the second locking element is allowed to exit the gap. Thus, the door 1 can be opened. In other words, when the acting element is in the front position, the safety catch is on and the locking elements are overlapping, the locking is closed. When the safety catch is off while the acting element is still in the front position and the locking elements are overlapping, the locking is open, in which state a force acting on the locking elements or the counter part, separating the units, will pull the second locking element from the gap, whereby the second locking element will simultaneously pull the acting element into the withdrawn position, and whereby the other free end moves past the first free end.

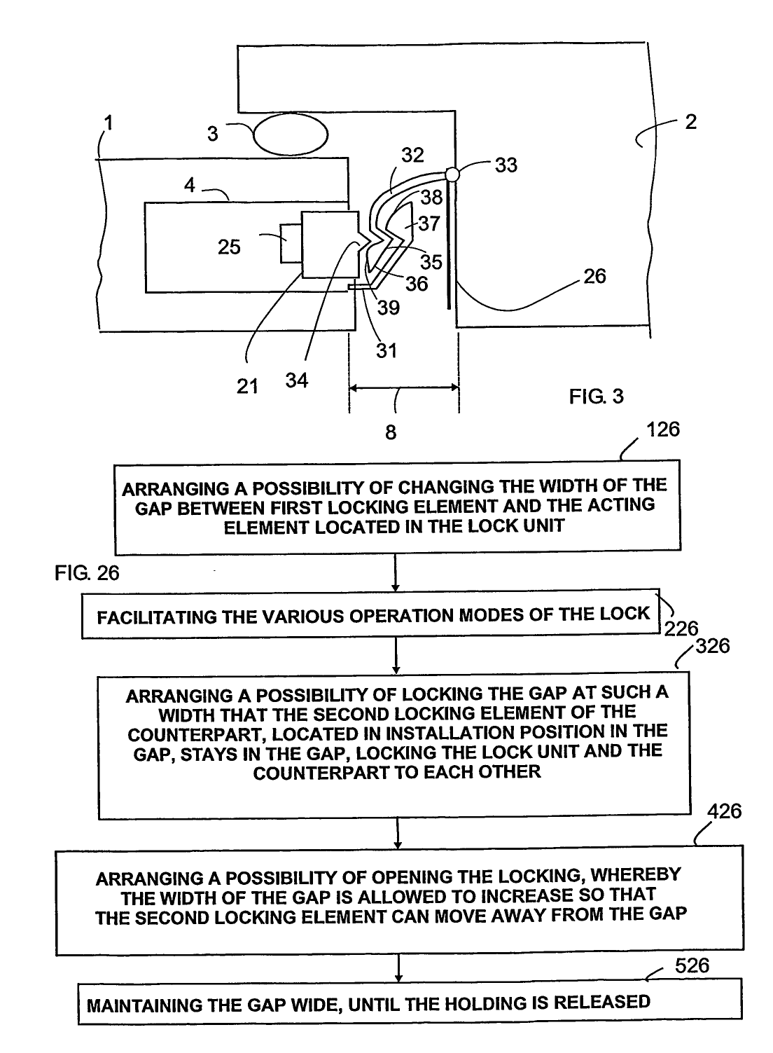

FIG. 3 illustrates another simple example of the construction according to the invention as seen from above, with the locking arrangement installed to the door and the frame, in which arrangement the locking elements are formed differently from those in FIG. 2. The free end 36 of the second locking element 32 is formed so that the inner edge 35 of the bracket, beginning from the free end, is slanted, and the outer edge 39 on the other side of the bracket is curved. The bracket is fastened to the counter part by means of a hinge 33 or the like, whereby the hinge will allow the bracket to move within a desired degree range. This movement can also accommodate different door clearances and the fluctuation of the clearance. The free end 37 of the first bracket 31 has also been formed, whereby it's inner edge 38 has been bevelled.

The bevelled surfaces 35, 38 make it easier for the brackets to overlap when the door is being closed. The curved surface 39, on the other hand, will ensure that there's always an effective contact surface between the second locking element and the second locking element, if there's an attempt at opening the door. When the locking is on, the acting element 21 can not move to the withdrawn position, but its gripping bracket 34 presses the second locking element 32 upon opening the door, the second locking element correspondingly being pushed against the first locking element 31. It can be seen from FIG. 3 that the form of the acting element and the two locking elements can have an effect on the operability of the locking arrangement. Additionally, it can be seen that it is preferable for the fastening of the second locking element to the counter part to be, e.g. a hinged fastening 33, whereby a certain movement of the second locking element is allowed. The second locking element could also be manufactured from a resilient material, whereby the hinged fastening or the like fastening is not necessary, as the locking element itself allows a certain movement. The material can be resilient in only a certain part of the locking element, such as the bottom of the locking element.

It is also preferably for the construction of the counter part to include a spring for keeping the second locking element in a desired position, in which the door is open.

In FIGS. 2 and 3 the gaps between the brackets and the acting element are exaggerated for reasons of clarity. In reality the gaps are considerably smaller. Thus, FIGS. 2 and 3 illustrate the principle of the invention, and they therefore are not accurate embodiments as far as shapes and scales are concerned.

FIG. 4 illustrates a simple exemplary situation of an acting element 40 according to the invention as seen from the side of the lock unit 48. The figure does not show the first lock unit, but it is only intended to illustrate the action of the acting element and the safety catch 43. In FIG. 4 the acting element 40 is in the front position, whereby the gripping bracket 41 on the side of the front surface 411 thereof is in front and the gap between it and the first locking element is at its smallest. The acting element is formed of an stem-like construction (arm), being fastened to the body of the lock unit at the position of the hinge means 42, at the first end of the arm, i.e. the upper end thereof. Thus, the arm can turn about the hinge point formed by the hinge means.

In addition to what is described above, the lock can also be installed upside down in relation to FIG. 4 (and other Figures), whereby the hinge means 42 is in the lower end of the arm in the installed position. It is, however, easier to describe the invention so that the hinge means is up, as shown in the appended figures. Thus, this text refers to an installed position, whereby the hinge of the arm is in the upper end. It is additionally possible to arrange the arm in a horizontal position, if the width of the construction is sufficient. This alternative is mainly considered when it is desired to install the lock unit in the frame structure of the door (i.e. the thickness of the wall can be used for installing the locking arrangement in the desired position).

The safety catch 43, by means of which the acting element can be locked in the front position, is preferably located in the lock unit, so that the reel 47 of the safety catch firmly presses the rear surface 410 of the arm at the lower end thereof (i.e. the other end of the arm). Thus, the rear surface is a counter surface, on which the safety catch is pressing. The pressure on the counter surface is as firm as possible when the radius of the reel of the safety catch points perpendicularly to the counter surface. When the safety catch is on, i.e. it locks the arm in the front position, the centre 44 of the reel is on the level of the rear surface of the arm or inside it. Thus, the rear edge is the edge of the counter surface (surface that the safety catch presses on when on) and the area inside the rear edge is the area of the counter surface. The safety catch also comprises an arm 49, hinged 45 by its other end to the body of the lock unit, whereby the arm can move in relation to the hinge point defined by the hinge. The other end of the hinge is hinged 46 to the drive construction, not shown in FIG. 4.

FIG. 5 illustrates another simple exemplary situation of an acting element according to the invention seen from the side. In this case the safety catch 43 is not on, i.e. the acting element 40 is not locked in the front position. The force transmitted from the drive construction via hinge 46 has moved 51 the arm of the safety catch downwards while the relation of the fastening hinge point 45 of the arm has kept the other end in place. Thus the centre 44 of the reel 47 has moved to the outer edge of the acting element, whereby the reel no more firmly presses the rear surface of the arm. In this operational state the lock is open and the acting element is allowed to move to the withdrawn position. In a practical installation situation this means that when the lock unit is installed in the door, the door is closed, but it can be pushed/pulled open.

FIG. 6 illustrates a third simple exemplary situation of an acting element according to the invention, seen from the side. In this example the door is pushed/pulled open in a practical installation situation. Thereby the force of the opening of the door acting on the gripping bracket 41 of the acting element 40 pushes the arm towards the withdrawn position while the hinge point 42 keeps the upper end of the arm in place. As the lower end of the arm moves backwards, its rear surface simultaneously pushes the reel 47, so that when the centre of the reel is outside the rear surface the reel can move and simultaneously the arm of the safety catch moves downwards. (Please note that if the lock unit is installed the other way round, the directions of the operations are reversed.) This operation of the safety catch 43 allows the acting element to move 62 (preferably about 10 degrees) to the withdrawn position shown in the Figure. The fastening hinge point 45 of the safety catch will keep the fastening end of the safety catch in place and the drive construction allows the other end of the arm to move 61 down.

In a practical installation situation, when the arm is in withdrawn situation, this means that the door is open. Thus, it is also preferable to keep the arm in the withdrawn situation until the door is closed again, whereby the arm is allowed to move back to the front position. It is preferable to simultaneously arrange the release of the safety catch to its upper position (e.g. by means of a spring belonging to the safety catch or the drive construction), whereby the door is again closed and the lock unit is in the state shown in FIG. 5. Thus, FIGS. 4-6 illustrate the principle of the invention, and they therefore are not accurate embodiments as far as shapes and scales are concerned.

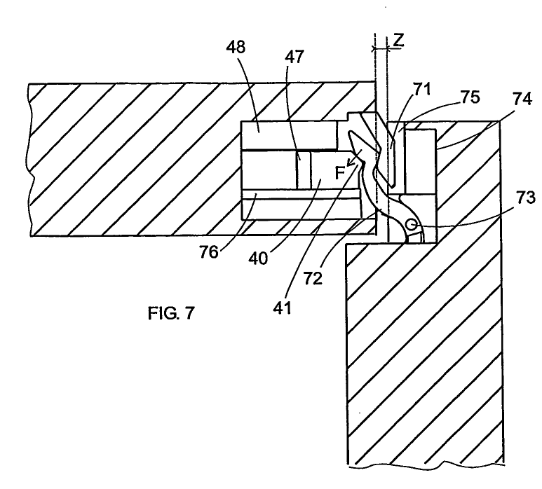

FIG. 7 illustrates an example of the form of the gripping brackets and of adjusting the locking arrangement for different door clearances. FIG. 7 shows in more detail the same constructions that were schematically shown in FIGS. 4-6, as seen from above. The lock unit 48 is installed in the door and the counter part 74 is installed in the door frame. The door and the lock are closed in this example. The other locking element 72 has just enough space between the first locking element and the acting element 40. The reel 47 of the safety catch keeps the acting element in place. If it is now attempted to open the door, a perpendicular force F acts on the gripping bracket 41 of the acting element due to the form of the second locking element. This force tends to move the acting element to the withdrawn position, but the reel of the safety catch prevents it.

Part of the force F is moved via the friction surface 76 to the body of the lock unit. The operability of the lock can be effected on by means of the properties of the friction surface. If the friction coefficient of the friction surface is small, the acting element moves easier when opening the door, but simultaneously a larger force acts on the safety catch. The larger the force acting on the safety catch, the more energy is needed to open the lock, i.e. moving the safety catch off. This is important in for example panic situations (note the above-mentioned panic exit regulations). If, on the other hand, the friction coefficient of the friction piece is larger, a larger part of the force of opening the door is used on the friction surface, whereby less energy is needed for moving the safety catch. In practical solutions the friction coefficient is preferably about 0.3. The friction surface is on the side of the acting arm acting as a support surface as the opening force acts on the gripping bracket of the acting element, while the friction surface and the support surface are in contact with each other during the said opening force F. The opening force is essentially on the level of the gripping surface of the acting element. Structurally the friction surface can be a part of the actual structure of the lock body, acting element or a friction piece fastened to the body or the acting element.

The locking arrangement is suitable for various door clearances Z (the gap between the door and the door frame). This is especially due to the hinge 73, via which the second locking element is fastened to the counter part 74. The hinge and the construction of the counter part allow the locking element to move within a certain angle sector (preferably about 10-15 degrees), whereby the overlapping of the first and second locking element is made possible. The shapes of the locking elements make the overlapping easier as well. As can be seen in FIG. 7, with the clearance Z of this example there must be an indentation 75 in the counter part 74, into which the first locking element enters when the door is being closed. With a larger clearance the indentation might not be necessary. The door clearance is typically between 1 to 5 mm. The shape, size and even necessity of the indentation can be effected on by the shape and location of the locking elements.

It can be seen in FIGS. 7 and 3, that seen from the first free end (37, FIG. 3), after the bevelling, the inner edge of the bracket of the locking element comprises a notch. The outer edge of the second locking element comprises a convex curved surface adjacent the second free end or beginning from the second free end. The bevelled surface of both the curved surface and the inner surface of the second locking element terminate at the arm of the bracket at a point in which the arm starts to curve outwards, forming a curve before the fastening end of the bracket of the second locking element, whereby an indentation is formed between the curved surface and the curve. The gripping bracket of the acting element comprises a tab, which is located in the position of the indentation of the bracket of the second locking element when the gap is at its narrowest and the brackets are overlapping, whereby in this position the inside surface located in the position of the indentation of the second locking element additionally settles into the notch of the first locking element. The surfaces of the tab of the gripping means are essentially straight on both sides of the ridge or on the side of the tab on which the force, if any, from the second locking element is acting.

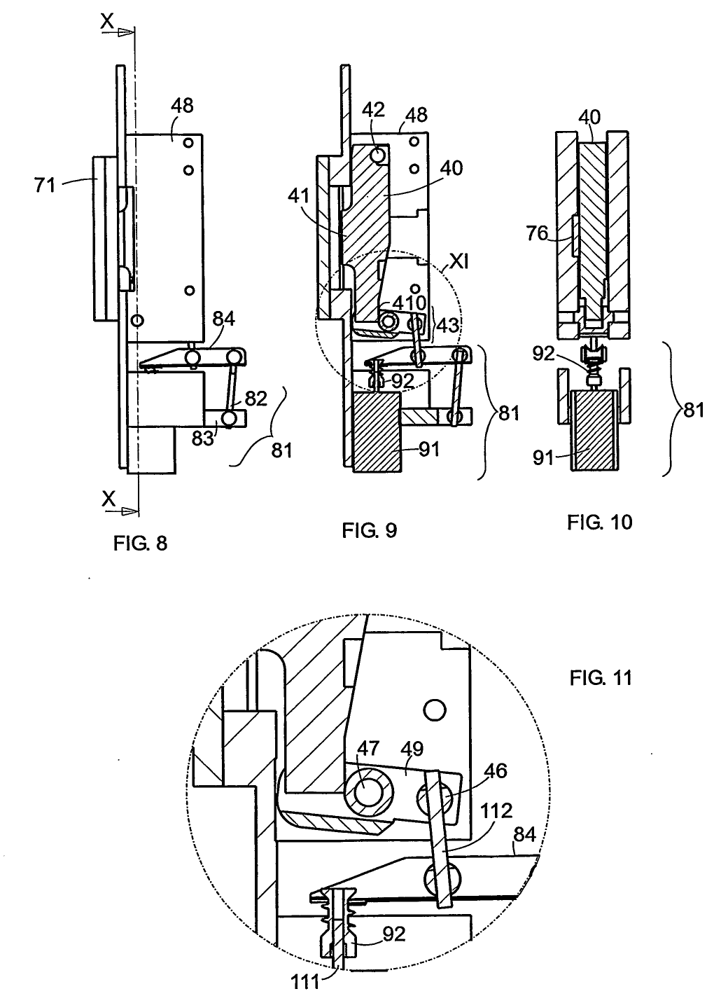

FIG. 8 illustrates a first example of the drive construction 81 of the lock unit with the safety catch on. A section line and a direction for the sectional view of FIG. 10 have been marked in FIG. 8. FIG. 9 illustrates a sectional view of FIG. 8, seen from the same direction. In FIG. 9, the part of which FIG. 11 is a partial enlarged view, is indicated with a dotted line. FIGS. 8-11 illustrate the structures of FIGS. 4-7 in more detail.

In the first example, the drive construction 81 comprises a transferring arm 112, which is hinged 46 by its one end to the arm 49 of the safety catch and by its other end to the other drive construction. The other drive construction comprises a transmission screw 92, a transmission arm 84 and a supporting arm 82, which is hinged by its one end to the body of the lock unit, in this example via support 83, and by its other end to the other end of the transmission arm 84.

In closer detail, the transmission screw is supported by its other end to the screw thread of the transmission screw and hinged by its central part to the transferring arm 112, whereby the power, if any, rotating the screw will move the other end of the transmission arm in the screw thread, as a result of which the movement of the transmission arm will move the transferring arm, whereby the arm of the safety catch will also move. In this example, the transmission screw is connected to the electric motor 91 via shaft 111. The electric motor produces the force, if any, rotating the screw. The electric motor can also be connected to a control unit. Typically, the control unit controls the operation of the motor in response to external signals, which can be control signals, signals indicating a panic situation or the like. The transmission screw can alternatively or additionally be connected to a mechanical power apparatus.

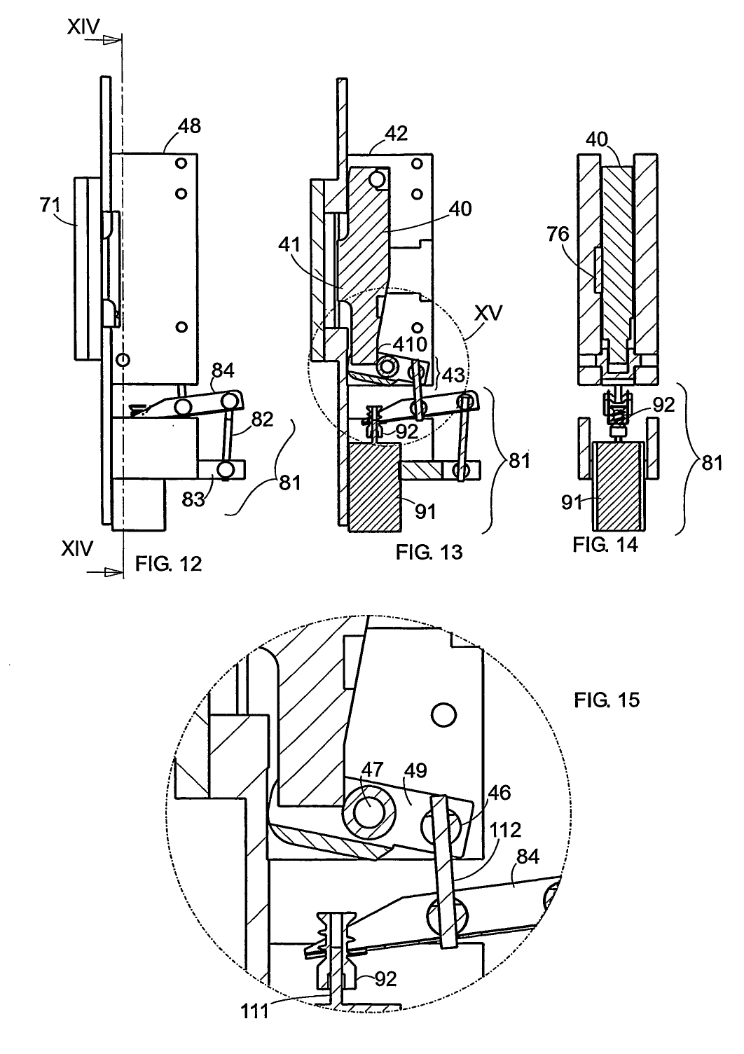

Thus FIGS. 8-11 illustrate a situation in which the acting element is in front position and the lock closed, i.e. the safety catch is on. If an electric motor is used for rotating the transmission screw, the position of the safety catch can be changed. FIGS. 12-15 illustrate a situation in which the first drive construction is in the second position, in which the safety catch is off and the acting element 40 is in the front position. The safety catch has been pulled down via the transmission screw so that the centre point of the reel 47 of the safety catch is below the lower edge of the acting element. Thus, the acting element can be moved to the withdrawn position by external power.

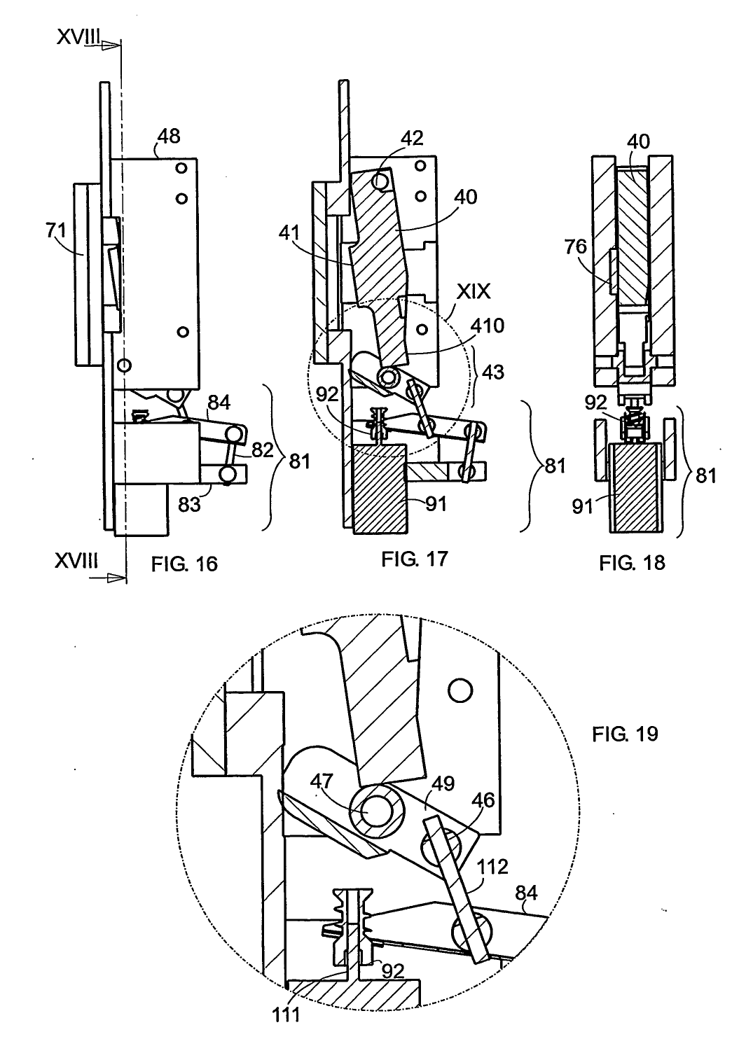

FIGS. 16-19, on the other hand, illustrate a situation, in which the acting element has been moved to the withdrawn position by the external force while the safety catch is off. In this situation the reel of the safety catch is totally below the acting element. It is preferable for practical operation to keep the acting element in the withdrawn position until, for example, when closing a door, it is allowed to again move to the front position. A spring is used for this purpose, the spring being described later in more detail. It is to be noted that in FIGS. 8-10, 12-14 and 16-18 there is a spring around the part 82 pushing the parts 83 and 84 apart. This spring causes the drive constructions to automatically return to the desired position when the acting element moves from the withdrawn position to the front position.

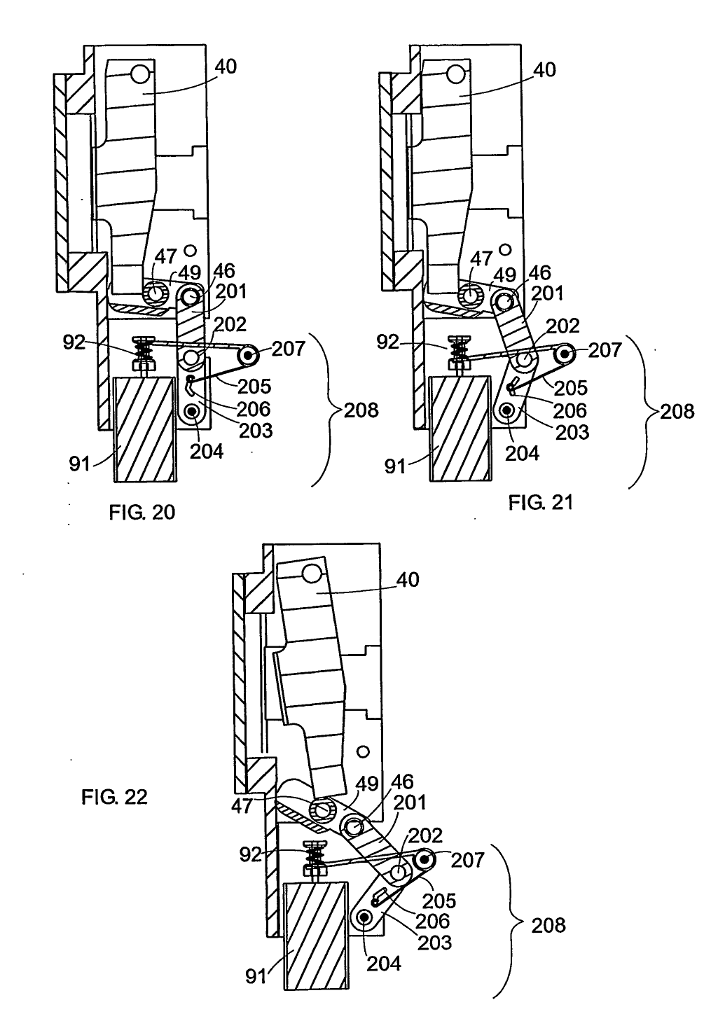

FIGS. 20-22 illustrate an example of another drive construction 208. In this construction the drive construction comprises a transferring arm 201, hinged 46 by its one end to the arm 49 of the safety catch and by its other end 202 to the other drive construction. The other drive construction comprises a transmission screw 92, transmission spring 205 and a supporting arm 203, hinged 204 by its one end to the body of the lock unit and by its other end to the said transferring arm.

The transmission spring is essentially u-shaped and it is supported by its one end to the screw thread of the transmission screw 92 and by its other end to the central part of the supporting arm, in more detail to the fastening notch 206, in which the fastening end of the spring can move. Additionally, the spring (preferably a coil spring) is supported 207 at the curve to the body of the lock unit.

The force, if any, rotating the screw 92, moves the end of the spring supported in the screw thread, whereby the movement of the spring 205 moves the supporting arm 203 and the transferring arm 201 via the supporting arm fastening, whereby also the arm 49 of the safety catch moves. In FIG. 20 the safety catch is on and the acting element is in front position. In FIG. 21 the safety catch is off and the acting element is in front position, and in FIG. 22 the safety catch is off and the acting element is in withdrawn position.

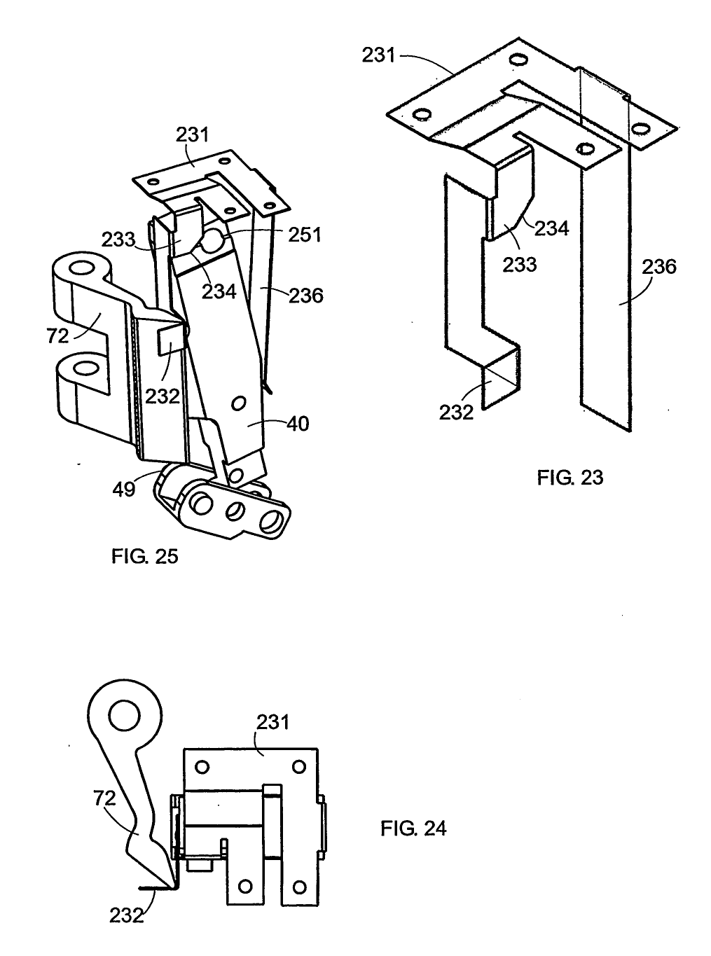

FIG. 23 illustrates an example of the holding spring 231 of the locking arrangement, the purpose of which is to maintain the acting element in the withdrawn position, for example when the door is open. The holding spring can be made of, for example metal, but it can also be made of another material, such as a suitable plastic. A part of the holding spring 233, called the holding surface, keeps the acting element in the withdrawn position. In order to ease the operation of the spring there preferably is a bevelling 234 in the holding surface of the spring. When the door or the like is being closed, the free end of the second locking element 72 contacts the part 232 of the spring release bracket, the part being called the release surface, whereby the locking element pushes the release surface. Because the spring is made of a resilient material, the push by the second locking element deflects the spring, whereby the holding surface moves, allowing the acting element to move into the front position. FIG. 24 illustrates, seen from above, how the second locking element has an effect on the holding spring. The holding spring also comprises a pushing part 236, which pushes the acting element towards the front position, thus securing the movement of the acting element to the front.

FIG. 25 illustrates an example of the operation of the holding spring 231 together with the second locking element 72 and the acting element 40. It can be seen in the Figure that the acting element includes a bevel 251, with which the holding surface 233 of the spring abuts when the acting element is in the withdrawn position. In this example the acting element is still in the withdrawn position, and the second locking element has just pushed the release surface 232 of the spring, whereby the spring is deflected and the holding surface 233 moves away from the bevel 251. The acting element can now move to the front position. The pushing part 236 of the spring ensures the movement.

FIG. 26 is an exemplary flow chart of the method according to the invention. Because the locking arrangement according to the invention includes operations that are non-existent in prior art arrangements, the invention also relates to a method for the operations of the locking arrangement according to the invention. The method offers 126 a possibility to change the gap between the first locking element and the acting element in the lock unit and facilitate the various operation modes of the lock 226. Changing the width of the gap thus means changing the position of the acting element, and making the operation modes possible means that the position of the acting element and the state of the safety catch described above (on, off, pushed down) together form the operation mode of the lock. These operations 126, 226 are basic operations that can be completed by other operations.

In order to lock the lock, a position in which the gap is locked 326 to such a width that in the above-mentioned installation position the second locking element of the counter part stays in the gap. locking the lock unit and the counter part together, is needed.

Additionally, in order to open the lock, a possibility of opening 426 the locking is offered, whereby the width of the gap is allowed to increase so that the second locking element is allowed to move away from the gap. The method can further include an auxiliary operation, whereby the gap is kept 526 wide while it is wide, until the holding is released, whereby the gap is allowed to decrease in width.

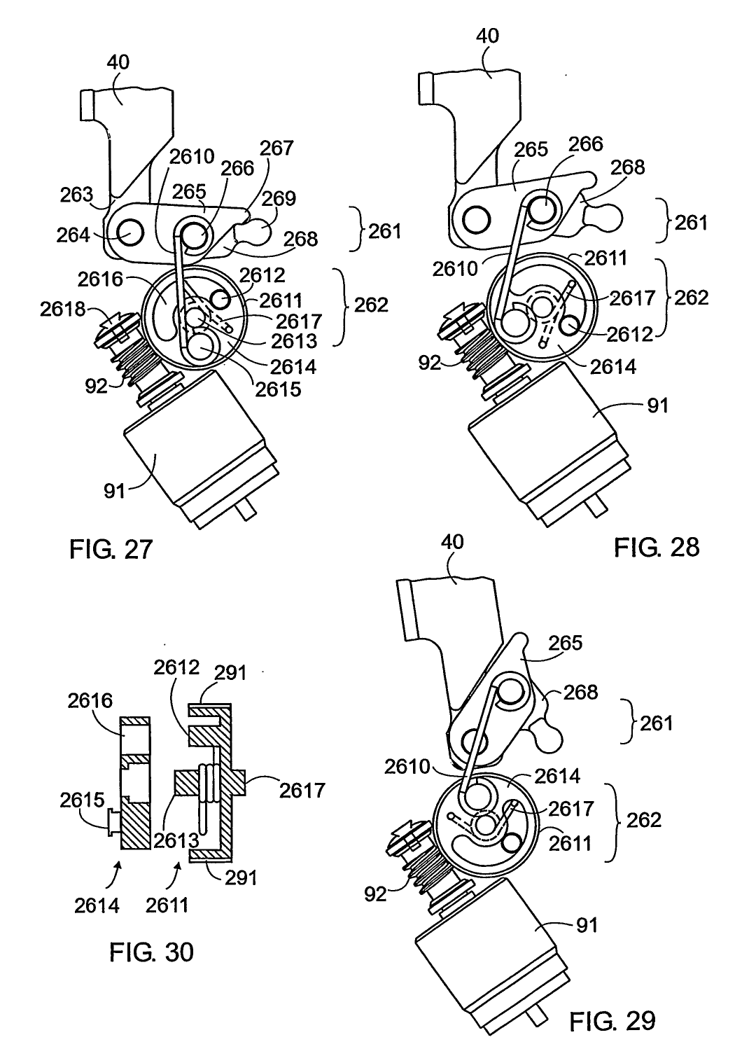

FIGS. 27 to 29 describes yet another drive construction 262 and an embodiment of a safety catch 261. As can be seen in these figures, the safety catch 261 comprises two arms 265, 268 which have been hinged 266 together at the other ends of the arms. The first arm 265 has also been hinged 264 to the lower end 263 of the acting element 40. The lower end 263 is preferably chamfered. The end of the first arm 265, which comprises the hinge 266 for the hinging with the second arm 268, also comprises a bracket 267 for forming a toggle joint with the other end 269 of the second arm. The other end 269 of the second arm comprises a locking surface for the bracket 267 of the first arm, and also forms a support joint against the lockbody (not showed in the figures). The support joint has been secured (not showed in the figures), for example, by a screw that allows turning of the end 269 of the second arm.

The drive construction 262 of the FIGS. 27-29 has been connected with the safety catch 261 through a transferring arm 2610. The drive construction also comprises a drive wheel 2614 and a worm wheel 2611. The end of the transferring arm 2610 has been connected to the hinge point 266 of the arms of the safety catch. The other end of the transferring arm has been connected to the drive wheel 2614, more particularly to a connection pin 2615 of the drive wheel.

The drive wheel comprises a central hole and a drive hole 2616. The worm wheel comprises a central pin 2613, a drive pin 2612 and a gear cutting 291 on the edge of the wheel. The drive wheel is attached to the worm wheel so that the drive pin 2612 penetrates to the drive hole 2616 and the central pin 2613 to the central hole. The edges of the worm wheel cover the edges to the drive wheels. FIG. 30 shows the drive and worm wheels. A spring 2617 is situated between the wheels. The spring is put around the central pin 2613 of the worm wheel and the first end the spring is attached to the worm wheel and the second end to the drive wheel as showed in FIGS. 27-29.

The gear cutting 291 of the worm wheel matches with the screw thread of the transmission screw 92, i.e. with the worm screw, that is fixed onto the axis of the electric motor 91 through a coupling gear 2618. The coupling gear 2618 between the axis of the electric motor and the worm screw is for preventing the screw getting blocked and for saving electric energy. The coupling gear slides in desired situations in which cases the drive from the electric motor to the worm wheel is cut.

In FIG. 27, the acting element 40 is at the front position. The safety catch 261 is locked as the toggle joint is at the safety angle. The worm wheel has been driven counter-clockwise to the lock position by the electric motor, when the drive pin 2612 is at the desired position. When driven to this position, the spring 2617 has been strained at the same time. This strain has discharged when the door is closed rotating the drive wheel, moving the transferring arm and locking the toggle joint. A little pre-strain remains in the spring 2617. In other words, FIG. 27 shows a door closed—lock locked situation.

FIG. 28 shows the situation wherein the safety catch 261 has been driven open by the electric motor 91. The worm screw has rotated the worm wheel 2611 clock-wise via the connection between the screw threads and the gear cutting 291. The drive pin 2612 of the worm wheel in the drive hole 2616 has forced the drive wheel to turn as well. The turn of the drive wheel has moved the transferring arm 2610 that moved the toggle joint open. The spring 2617 has moved but not forced to be in any extra strain. In other words, FIG. 28 shows door closed—lock open situation.

If a door is moved open when the lock is open, the acting element 40 moves to the back position as described in FIG. 29. The arms 265, 268 of the safety catch 261 turn in respect of the hinge points of the arms allowing the acting element to move back. The transferring arm 2610 moves as well turning the drive wheel clock-wise at the same time. At this time, the worm wheel does not rotate. The drive pin stays still in the long drive hole 2616 that moves along the drive wheel. At this time, however, the spring 2617 is forced to be in extra strain. In other words, FIG. 29 shows door open—lock open situation.

The acting element 40 stays still in the back position with the help of the holding spring 231, but when the door is closed, the extra strain of the spring discharges rotating the drive wheel counter-clockwise. The rotation of the drive wheel moves the safety catch 261 either the lock position of FIG. 27 or the open position of FIG. 28. The safety catch 261 moves to the lock position if the worm wheel is driven counter-clockwise to the lock position as showed in FIG. 29 when the door is open or when closing the door. In this, way, the spring gets more strain for moving the safety catch to the lock position.

As has been described above, the width of the locked gap is such that the second locking element has just enough space there, whereby the second locking element stays in the gap due to the form of the gap, which is due to the design of the locking elements and the acting element. There are many design alternatives. For example, the above-mentioned surface of the gripping bracket does not have to be straight (straight on both sides of the bracket or on other side), but it can follow the form of the other one, i.e. it can be, for example, concave. The locking elements and the acting element can thus be, for example, cylindrically formed (concave on one side and convex on the other side).

Due to the shape, geometry, mutual operation and the friction surface of the parts of a lock according to the invention, an opening force of, for example, about 500 Newton acts on the reel of the safety catch with a smaller force (preferably with a force of only about 80-90 N). If the safety catch is now moved 1 mm, a considerably smaller force, preferably even only 10 N, is needed to overcome the frictional force and the rolling resistance. The drive construction further decreases the necessary power output from the electric motor and because the movement of the safety catch is short, the necessary amount of energy is less than 100 mJ, preferably only of the order of 10 mJ. Thus, due to the short movement and small force, no expensive and complex transmission is needed for the electric motor, but instead, a simple screw pinion and lever will turn the rotation of the motor into the necessary movement of the safety catch. The necessary torque can easily be produced with, for example, a small DC motor. Because the necessary motor revolutions are few and no separate reduction gearing is needed due to the low torque, the operation time of the motor per one opening/closing is very short.

Thus, the system according to the invention uses much less energy for opening and closing the lock than prior art locks. The locking element itself, such as the latch, is not moved, but only the safety catch is moved a short distance (a few millimetres). Further, the locking arrangement according to the invention utilises the opening and closing force of the door. The opening force pushes the acting element of the lock in the withdrawn position and the closing force releases the acting element back to the front position. The elements according to the invention lock the door and the door frame to each other so that if there is an attempt to open the door by wedging something into the door gap at the locking, the wedging in fact pushes the locking more closely together.

Additionally, in a locking arrangement according to the invention there is no need to use separate sensors for indicating whether, for example, the door is open, lock locked and lock open, but one sensor can indicate all this. When the sensor is observing the position of the safety catch, a sufficient amount of information about the state of the locking is produced.

The locking arrangement according to the invention can be produced by means of a number of solutions. The locking arrangement can, for example, comprise more than one lock per door or the like. The lock unit can be located in the door frame and the counter part can be located in the door or vice versa. The locks can be controlled, in addition to via wires permanently connected to the locks, via air as well, if the lock has a radio interface (such as a small radio transmitter/receiver). Thus, the locking of large housings can also be centrally controlled. The voltage supply and/or control can be introduced into the lock via contact surfaces in the door and the door frame when the door is locked.

The above-mentioned gripping brackets can be fastened to the lock body in a number of ways. For example, in addition to the gripping bracket being fastened by its one end, it can also be fastened above and below it. Additionally, the gripping bracket, especially the gripping bracket fastened to the lock unit, can in a way be sunk into the lock body. In different solutions it is essential that there be a gap between the first locking element and the acting element, into which the second locking element can enter and into which it can be locked (it can be said to be wedged there).

Further to the fact that the gripping surface, i.e. the gripping bracket, of the acting element has been described as a protruding tab, it can also be a groove. In this embodiment the shape of the groove follows the shape of the first locking element. The gripping bracket should in this context thus be understood as either a tab or a groove of the acting element. The gripping bracket can also be a structurally separate part. In this case the gripping bracket can be separately manufactured and fastened to the arm later.

The safety catch does not either necessarily include a reel. The arm can also include a part of another shape, the part giving sufficient support to the acting element when the safety catch is on and allowing the acting element to move to the withdrawn position when the safety catch is off. In other words, the construction of the safety catch can differ from that described in this disclosure.

The power needed by the operation of the lock does not have to come from the electric motor, but it can be produced in other ways as well, such as with a solenoid or the like, or mechanically (a traditional mechanical key).

On the basis of what's described above, it will be obvious that the invention can be carried out in ways other than those described here. Thus, the invention is not limited to the embodiments described here, but it can be carried out by means of a number of various solutions within the scope of the invention.

1. A locking arrangement comprising a lock unit and a counter part for locking a turnable door, hatch or the like, and a door frame or the like together, the lock unit and the counter part being installable in the said lockable parts, characterised in
that the lock unit includes a first locking element comprising a first free end and which in the installation position is mainly transversely in relation to the swing axis of the turnable part,
that the counter part includes a second locking element comprising a second free end and which in the installation position is mainly transversely in relation to the swing axis of the turnable part,
that the said locking elements are arranged to work together so that when the said units are against each other in their installation position while the door, hatch or the like is in its closed position, they are overlapping each other,
and that the arrangement comprises an acting element that comprises an arm, the first end of which includes a hinge means and the arm includes a gripping bracket, while the acting element is fastened to the body of the lock unit by the hinge means, whereby the arm can turn in relation to the hinge point formed by the hinge means,
when various modes of locking can be produced depending on the position of the arm, and which arm being controllably supported, the locking is achieved,
which arm is arranged to act transversely in relation to the said locking elements for achieving the locking so that in the said position the overlapping locking elements together with the acting element prevent the lock unit and the counter part from moving away from the said position being against each other by causing the said units to grip each other.

2. An arrangement according to claim 1, wherein the lock unit comprises a safety catch for the acting element for controlled support of the acting element,
by means of which the acting element is locked in the front position for achieving the said locking, whereby the safety catch is on, and
by means of which the opening of the said locking is made possible, whereby the safety catch is off and the acting element is allowed to move in the withdrawn position.

3. An arrangement according to claim 2, wherein the first locking element is a bracket fastened by its one end to the body of the lock unit and the second lock unit is a bracket fastened by its one end to the body of the counter part, the free ends of the brackets allowing the brackets to be in the said overlapping position.

4. An arrangement according to claim 2 or 3, wherein there is a gap between the first locking element and the acting element, the width of which depends on the position of the acting element,
whereby the gap is at its widest when the acting element is in the withdrawn position and at its narrowest when the acting element is at its front position, in which front position the gap is arranged so that the second locking element has enough room for itself in the said overlapping position.

5. An arrangement according to claim 4, wherein while the acting element is in the front position and the safety catch is on and the locking elements are overlapping the locking is closed,
and when the safety catch is off while the acting element is still in the front position and the two locking elements are overlapping each other, the locking is open, in which state a force acting on the lock unit or the counter part, separating the units, will pull the second locking element from the gap, whereby the second locking element will simultaneously push the acting element into the withdrawn position, and whereby the second free end moves past the first free end.

6. An arrangement according to claim 5, wherein it comprises a holding spring for keeping the acting element in the withdrawn position, whereby the locking is open with the acting element in the withdrawn position.

7. An arrangement according to claim 2, 3, 3, 5 or 6, wherein the safety catch comprises a reel, the central point of which is on the side of the acting element while the circumference of the reel presses on the counter surface formed by the rear edge of the arm when the safety catch is on and
when the safety catch is off, the central part of the reel is outside the rear edge of the arm, whereby the reel allows the arm to be moved into its withdrawn position by an external force.

8. An arrangement according to claim 7, wherein the safety catch comprises an arm, onto which a reel is fastened, and
which is fastened by its fastening end to the body of the lock unit via a second hinge and by its other end to the drive construction structures,
while the arm of the safety catch can be moved in relation to a second hinge point formed by the second hinge by the power, if any, acting on the acting element or transmitted via the drive construction.

9. An arrangement according to claim 8, wherein the force, if any, transmitted by the drive construction moves the arm of the safety catch so that the central point of the reel is on the side of the rear edge of the arm or outside it.

10. An arrangement according to claim 9, wherein the drive construction comprises a transferring arm, hinged by its one end to the arm of the safety catch and by its other end to the other drive construction.

11. An arrangement according to claim 10, wherein the other drive construction comprises a transmission screw, a transmission spring and a supporting arm, the arm being hinged by its one end to the body of the lock unit and by its other end to the said transferring arm,
the transmission spring being essentially u-shaped and supported by its one end to the screw thread of the transmission screw and by its other end to the central part of the supporting arm, the spring being additionally supported at its curve to the body of the lock unit,
whereby the force, if any, rotating the screw, moves the end of the spring supported in the screw thread, whereby the movement of the spring moves the supporting arm and the transferring arm via the supporting arm fastening, whereby also the arm of the safety catch moves.

12. An arrangement according to claim 10, wherein the other drive construction comprises a transmission screw, a transmission arm and a supporting arm, the arm being hinged by its one end to the body of the lock unit and by its other end to the transmission arm,
the transmission arm being fastened by its one end to the screw thread of the transmission screw and hinged by its central part to the transferring arm,
whereby the force, if any, rotating the screw will move the other end of the transmission arm supported in the screw thread, whereby the movement caused by this will move the transferring arm, thus also causing the arm of the safety catch to move.

13. An arrangement according to any of the claims 10-12, wherein the transmission screw is connected to an electric motor for producing the force, if any, rotating the screw.

14. An arrangement according to claim 2, 3, 4, 5 or 6, wherein the safety catch comprises a first arm and a second arm that have been hinged together at the first ends of the arms forming a toggle joint between the arms, the second end of the first arm being hinged to the lower end of the acting element and the second end of the second arm being hinged to the lockbody.

15. An arrangement according to claim 14, wherein the system comprises a drive construction that comprises a transferring arm, a drive wheel, a worm wheel, guiding means between said wheels and a transmission screw,
the transferring arm being connected to the hinge between the first and second arm and to the drive wheel,
the drive wheel being inserted into the worm wheel and being capable of rotating in respect of the worm wheel, both wheels having common axis point and being capable of rotating in respect of said axis point, the wheels being capable of turning each others via the guiding means in desired ways,
the drive wheel being in connection with the transmission screw when potential torsion force rotates the worm wheel, which in turn turns the drive wheel and the transferring arm moving the safety catch in a desired way.

16. An arrangement according to claim 15, wherein the drive wheel comprises a connection pin for the transferring arm, a central hole and a drive hole; and the worm wheel comprises a central pin, a drive pin and a gear cutting on the edge of the wheel,
the drive wheel being attachable to the worm wheel so that the drive pin penetrates to the drive hole and the central pin to the central hole,
the system further comprising a spring, which is situated between the wheels, around the central pin,
the central hole and the central pin forming the common axis point, and the drive hole, the drive pin and the spring forming the guiding means.

17. An arrangement according to claim 15 or 16, wherein the system comprises a coupling gear through which the transmission screw is connectable to an electric motor.

18. An arrangement according to claim 13 or 17, wherein the arrangement comprises a control unit being connected to the electric motor.

19. An arrangement according to claim 18, wherein the control unit can control the electric motor as a response to an external signal.

20. An arrangement according to any of the claims 11-19, wherein the transmission screw is connected to a mechanical power apparatus.

21. An arrangement according to any of the claims 4-20, wherein the first free end is bevelled to the side of the inner edge of the bracket of the first locking element,
and the second free end comprises a bevelled surface on the side of the inner edge of the bracket of the second locking element, the bevelled surfaces facilitating the overlapping movement of the brackets.

22. An arrangement according to claim 21, wherein seen from the first free end after the bevel the inner edge of the first locking element comprises a notch,
the outer edge of the second locking element comprises a convex curved surface adjacent the second free end or beginning from the second free end,
while the curved surface of the second locking element and the bevelled surface of the inner edge terminate in the arm of the bracket at a point in which the arm starts to curve outwards, making a curve before the fastening end of the bracket of the second locking element,
whereby an indentation remains between the curved surface and the curve, and
the acting element comprises a tab of the bracket, which is located in the position of the indentation of the bracket of the second locking element when the gap is at its narrowest and the brackets overlapping, whereby in this position the inside surface located in the position of the indentation of the second locking element additionally settles into the notch of the first locking element.

23. An arrangement according to claim 22, wherein the surfaces of the tab of the gripping bracket are essentially straight on both sides of the tab or on the side of the tab onto which the force, if any, from the second locking element acts.

24. An arrangement according to any of the claims 6-23, wherein the arm comprises a groove into which the holding surface of the holding spring is located when the arm moves to the withdrawn position, whereby the arm stays in the withdrawn position.

25. An arrangement according to claim 24, wherein the holding spring comprises a releasing bracket, via which the force, if any, acting on the releasing bracket moves the holding surface away from the groove, whereby the arm can move to the front position.

26. An arrangement according to claim 25, wherein when the second free end passes the first free end and the brackets are moving into overlapping position the second free end pushes the releasing bracket of the holding spring.

27. An arrangement according to any of the claims 3-26, wherein the lock unit comprises a friction surface, located on the side of the side edge of the acting arm acting as a support surface when the opening force, if any, acts on the gripping bracket of the acting element, with the friction surface and the support surface being in contact with each other during the said opening force.

28. An arrangement according to claim 25, wherein the friction surface is essentially on the level of the gripping bracket of the acting element.

29. An arrangement according to any of the claims 3-28, wherein the second locking element is fastened via a second hinge to the counter part, making it possible for the second locking element to move in relation to the hinge point formed by the this hinge.

30. An arrangement according to any of the claims 3-29, wherein the counter part is provided with an indentation into which the first locking element settles when the units are in the said installation position.

31. An arrangement according to any of the claims 3-30, wherein the design of the locking elements and the acting element prevents the lock unit and the counter part from moving away from the said position against each other.

32. An arrangement according to any of claims the 2-31, wherein the locking arrangement comprises a sensor for observing the position of the safety catch.

33. An arrangement according to any of the claims 3-32, wherein the counter part comprises a spring for keeping the second locking element in the desired position.

34. A method for the operations of a locking arrangement, the locking arrangement comprising a lock unit and a counter part which are installable to structures to be locked to each other, chararacterized in that the lock unit is provided with a first locking element and an acting element, with a gap therebetween and that the counter part is provided with a second locking element,
while the first locking element comprises a first free end and the second locking element comprises a second free end, whereby when the said units are in installation position against each other, i.e. with the structures being against each other in their closed position, the locking elements are located overlapping each other,
in which method by means of the said components of the locking arrangement:
there is provided the possibility of changing the gap between the first locking element and the acting element,
the various operating modes of the lock are made possible, and
there is provided a possibility of locking the gap at such a width that in the installation position the second locking element of the counter part located in the gap stays in the gap, locking the lock unit and the counter part to each other.

35. A method according to claim 34, wherein the width of the locked gap is such that the second locking element has just enough space there, whereby the second locking element stays in the gap due to the form of the gap, which is due to the design of the locking elements and the acting element.

36. A method according to claim 34 or 35, wherein the locking is opened, whereby the width of the gap is allowed to increase, whereby the second locking element can move away from the gap.

37. A method according to claim 36, wherein when the gap is wide, it is maintained wide, until the holding is released, whereby the gap is allowed to turn narrower.
